(19) United States
(12) Patent Application Publication
(10) Pub. No.: US 2008/0149279 A1
(43) Pub. Date: Jun. 26, 2008

(54) Apparatus for displaying window covering samples

(76) Inventors: Patricia Marlin Leighty, Middleton, WI (US); Wayne S. Gourlay, Hortonville, WI (US); Ren Judkins, Pittsburgh, PA (US)

Correspondence Address: BUCHANAN INGERSOLL & ROONEY PC, P.O. BOX 1404, ALEXANDRIA, VA, 22313-1404, US

(21) Appl. No.: 11/643,303

(22) Filed: Dec. 21, 2006

(51) Int. Cl. E06B 9/24

(52) U.S. Cl. 160/10

(57) ABSTRACT

A window covering sampling device has a plurality of different segments of at least one window covering material connected in series to form a sample panel. In one embodiment, indicia are located on at least one segment to identify at least one of the several different segments. In another embodiment, at least one label, strip or hang tag is attached to at least one segment and contains indicia to identify at least one of the plurality of different segments. In yet another disclosed embodiment, a kit having a plurality of different segments of at least one window covering material is connected in series to form a sample panel and a separate segment identifier is provided in the kit. A device for mounting the sample panel over a window may be attached to one of the segments.

### FIELD OF THE INVENTION

This invention relates to an apparatus for displaying window covering samples, wherein a plurality of different segments of at least one window covering material are connected in series to form a sample panel.

### BACKGROUND OF THE INVENTION

The general practice for selling window coverings involves the use of various sampling devices to display the available materials for window covering products to a potential customer. Generally, these sampling devices include conventional display cards or books that contain swatches of the various color and fabric options available to a customer. One such book is disclosed in U.S. Pat. No. Des. 334,587. The samples contained in these sample books or display cards are typically very small, ranging in length and width of about one half inch to two inches of material provided as each sample. Some samples of pleated and cellular material, while small, are also extendable such that a potential customer can stretch the sample to view the sample in open and closed positions. The fully extended length of such a sample is typically from one to three inches.

Various other devices are similarly used for displaying samples of various home decoration materials, such as carpeting, flooring, and wall coverings. For example, U.S. Pat. No. 6,270,123, discloses sampling cards used for paint color samples and U.S. Pat. No. 3,430,346, discloses sampling cards used for fabric samples. These sampling devices also contain small swatches of available materials.

Spangler, in U.S. Pat. No. 6,270,123, teaches the use of small color stripes positioned in side-by-side relation on paper strips, which are placed on a display rack. Potential customers review the display rack to determine the various color options available to the customer and, optionally, can remove various paper strips from the display rack. However, Spangler's devices are not intended for use in the selection of fabrics or window coverings.

Kirschbaum, in U.S. Pat. No. 3,430,364, discloses a device for exhibiting samples of fabrics used in upholstering and slip-covering furniture. Kirschbaum teaches the use of a large sample swatch of a single fabric sample that is free hanging and is suspended from a backing sheet. Smaller samples of the fabric are then attached to the backing sheet and exhibit various colors or patterns available for the specific fabric type. Kirschbaum, however, does not teach the use of exhibiting different upholstery materials in the same device. Moreover, Kirschbaum's devices are not intended for use in the selection of window coverings. None of the sample exhibiting devices permit a potential customer to review a sample of a window covering material in a format similar to how the material will be hung in a window.

The standard sample display devices used in the window covering industry require customers to envision from a small swatch of material how a given window covering will look when hung to cover a window, which is typically several feet high and at least three feet wide. As a result, the process involved in choosing a window covering can take a relatively long time and can be confusing for customers because of the difficulty in envisioning what the customer's selected window material covering will look like when fabricated into a window blind and hung in his or her home or office. It is common for a customer to return a window blind because the product did not look like what the customer expected to see based upon his or her review of the sample.

The use of small swatches of material makes a customer physically compare multiple window covering options simultaneously. For any given product available in many fabrics and colors a customer may be required to review numerous sample display cards or books to determine a desired color and window covering material. This typical purchasing process often results in a customer spending hours trying to select a window covering material.

It is known to make sample shades consisting of a single window covering material typically 8 to 10 inches in width and attached to a small headrail or roller. Such sample shades may open to 24 to 36 inches in length. These sample shades are simply small scale versions of a full size shade being offered for sale.

It is also known in the art to make full-size window coverings from multiple segments of window covering material. For example, U.S. Pat. No. 6,019,864, to Jones and U.S. Patent App. No. 2005/0224161 to Judkins disclose window coverings that are comprised of a plurality of fabric segments. Judkins and Jones teach that a window covering material used for a particular shade is usually cut from a larger panel leaving a smaller portion that is too small to be used in a single shade. They propose that these small segments that would otherwise be scrap, be combined to make a panel that can be used in a single shade. Jones also teaches that segments of different colors be combined to make a multi-colored full shade. However, neither Judkins nor Jones teach the use of connecting a plurality of fabric segments for sample displaying purposes. Instead, Judkins and Jones only teach the manufacture of window coverings.

Thus, there is still a need for a device for displaying window covering samples that permits potential customers to physically compare multiple window covering samples simultaneously in a format representative of the window covering's shape or structure. Such a device can eliminate the difficulty customers have in imagining the finished product and will permit the customer to better appreciate the differences among the available window covering materials.

### SUMMARY OF THE INVENTION

We provide an apparatus for displaying window covering samples, which has a plurality of different segments of at least one window covering material attached in series to form a sample panel. In one embodiment indicia are located on at least one segment to identify at least one of the segments. The indicia may be color, name, SKU number, fabric type, or fabric pattern. In another present preferred embodiment indicia are located on at least one hang tag that is attached to at least one segment of the plurality of different segments to identify at least one segment.

We provide another present preferred embodiment in which at least one strip is attached to the segments. Indicia are located on the strap or strips, to identify one or more of the plurality of different segments. One can provide a strip for each segment which contains information for only that segment or one can provide fewer strips, such as one for every pair of adjacent segments which has information about those two segments.

We also provide a kit for displaying window covering samples that has a plurality of different segments of at least one window covering material attached in series to form a sample panel and a segment identifier. The segment identifier may be a separate card or booklet, or several cards or booklets, and has at least one identifying member which contain indicia that identify at least one of the segments.

Other details, objects, and advantages of the invention will become apparent as the following description of certain present preferred embodiments thereof and certain present preferred methods of practicing the same proceeds.

### BRIEF DESCRIPTION OF THE DRAWINGS

In the accompanying drawings, we have shown certain present preferred embodiments of our invention in which:

FIG. 1 is a perspective view of a present preferred embodiment of our invention wherein several different segments of at least one window covering material are connected together to form a panel and having a strip containing identifying information attached to one of those segments.

FIG. 2 is top plan view of the strip used in the embodiment of FIG. 1.

FIG. 3 is a perspective view of a second preferred embodiment of our invention wherein a strip containing identifying information is attached to each segment.

FIG. 4 is a perspective view of a portion of the embodiment of FIG. 3 showing one of the strips extending beyond one side of the sample panel.

FIG. 5 is a perspective view similar to FIG. 4 showing a portion of a third present preferred embodiment wherein the strip extends beyond the front face of the sample panel.

FIG. 6 is a perspective view similar to FIGS. 4 and 5 of a fourth present preferred embodiment wherein indicia are located on the segment.

FIG. 7 is a perspective view of a fifth present preferred embodiment of our invention wherein a hang tag is attached to one segment of the plurality of different segments of at least one window covering material.

FIG. 8 is a perspective view of our sampling device in combination with a removable mounting device.

### DESCRIPTION OF THE PREFERRED EMBODIMENTS

Pleated shades, cellular shades and roman shades are available in a variety of woven fabrics, unwoven fabrics and films. These fabrics and films may be dyed or printed. Cellular shades may have a single cell or multiple cells and can be formed from the one fabric or film or from two different fabrics or films, typically with the front of the cellular material being different from the back of the cellular material. Pleated material and cellular material may or may not have a liner or black-out coatings applied to one face. Pleated material may be offered in different pleat sizes. Similarly, roman shade samples may have different seam or fold spacings and the material may or may not be hobbled. Venetian blinds are available in a variety of colors and may have metal, plastic or wooden slats. For purposes of this disclosure, window covering material shall include all such forms, except that two materials which differ only in color or pattern are considered to be the same window covering material. Two materials that differ only in color or pattern are different versions or segments of the same window covering material.

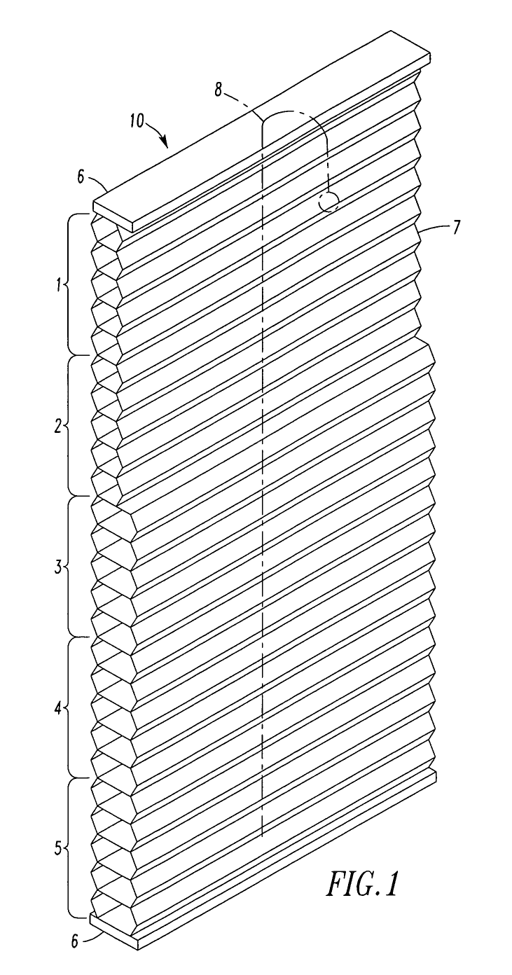

A present preferred apparatus for displaying window covering samples is shown in FIG. 1 wherein a plurality of different segments of at least one window covering material 7 forms a sample panel 10. Preferably, the sample panel 10 would have a width of six to twenty-four inches and a fully extended length of twelve to thirty-six inches. In the embodiment of FIG. 1, each of the segments 1 through 5, are single cell material with the cells in segments 1 and 2 being smaller than the cells in the other segments. However, it should be understood that the segments 1, 2, 3, 4, or 5 of the plurality of segments 7 can be made of any available window covering material, which includes, but is not limited to, cellular fabric, pleated fabric, single cell cellular fabric, double cell cellular fabric, triple cell cellular fabric, cellular film, pleated film, single cell cellular film, double cell cellular film, and triple cell cellular film, plastic slats, metal slats, and woven wood. Some segments may be single cell while other segments are multiple cell as in the embodiment shown in FIG. 7. One or more of the segments may be pleated material while others may be cellular material. In the embodiment of FIG. 1 a strip 6 is attached to the upper segment 1 and a second strip 6 is connected to the lower segment 5 of the plurality of different segments 7. The strip 6 can be made of cardboard, paper, wood, plastic or metal. We prefer that the strip 6 be rigid to act as a stiffener. Using a stiff strip on the top and the bottom of the sample makes it easier to open the sample evenly. We further prefer that the strip have a depth greater than the depth of the segments. Then, the strip will extend beyond the front face and rear face of the sample panel. Making the strip larger in this way reduces the likelihood that a user will touch the segments as he or she moves the strips apart from one another opening the sample panel. Repeated touching or handling of some fabrics may cause pilling as well as soil the material. We may also provide an elastic strap or pull cord 8 shown in dotted line to assist in retaining the panel in a collapsed position.

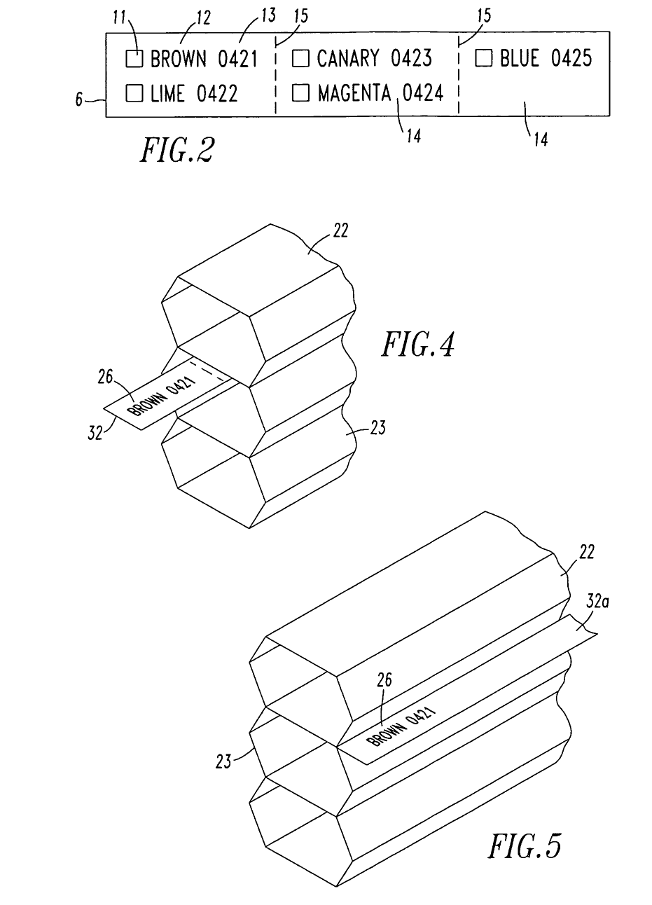

Indicia located on one or both of the strips 6 can identify the segments by color 11, name 12, and product number 13, as shown in FIG. 2. However, it should be understood that the indicia may identify the segments by various identification markings, including, but not limited to, SKU number, fabric type, or fabric pattern. In this embodiment, indicia located on the strip 6 identify all the segments of the plurality of different segments of at least one window covering material 7. However, it should be understood that the indicia on the strip may apply to all the segments where the differences are readily apparent. For example, where the segments differ only in cell size the indicia may be the fabric name or number which applies to all segments.

A potential customer can use this preferred embodiment for selecting a desired window covering by fully extending the panel and holding the panel over a window. The customer can compare the various different segments of window covering material. In so doing, the customer is capable of making a side by side comparison of various samples and physically witnessing the effect sunlight has on available materials. The panel also makes it easy to place the sample near furniture or drapery that may surround the window to be covered. In addition, the use of a panel comprised of several segments rather than individual segments allows the customers to see the texture and color of the samples in different lighting conditions. As a result, subtle differences among segments are easier to see. Because the customer can handle a panel of several segments rather than small individual samples, the customer needs less imagination to compare the various samples and to see how they will look in a finished shade.

A second present preferred embodiment of our apparatus for displaying window covering samples shown in FIG. 3 has a plurality of different segments of at least one window covering material 27 attached in series to form a sample panel 20. At least one strip is attached to each of the segments 21, 22, 23, 24 and 25 that together form the sample panel 20. For example, one strip 35 is only attached to one segment 25, but other strips 31, 32, 33 and 34 are attached to and between two segments. In this preferred embodiment, indicia may be located on each strip to identify the adjacent segment or segments of the plurality of segments 27. However, it should be understood that the indicia may only be on only one of the strips that identifies all of the segments.

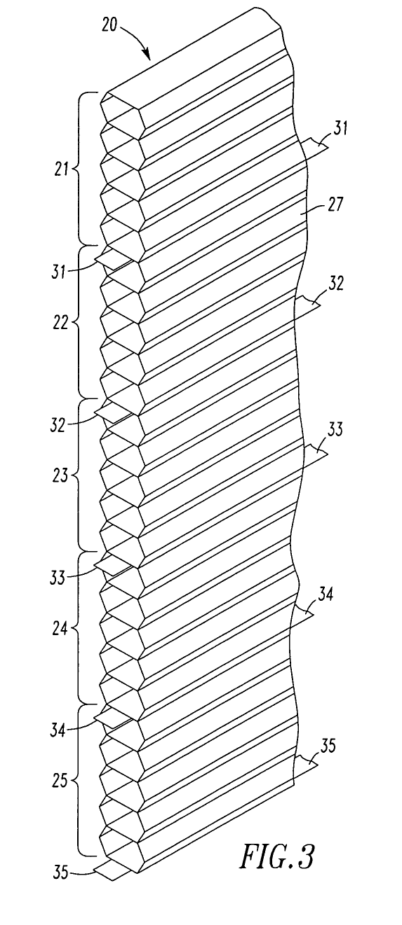

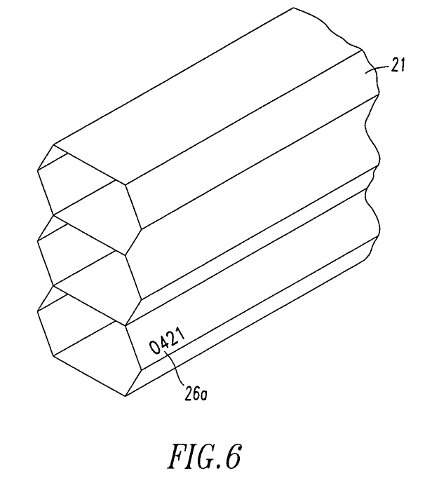

The strip or strips can extend beyond a side of the sample panel 20, as shown by strip 32 in FIG. 4. Similarly at least one strip 32a can extend beyond the front face of the sample panel 20, as shown in FIG. 5. All strips need not extend the same distance. Indicia 26 identifying at least one segment of the several segments is preferably located on the extended portion of such strip or strips, as shown in FIGS. 4 and 5.

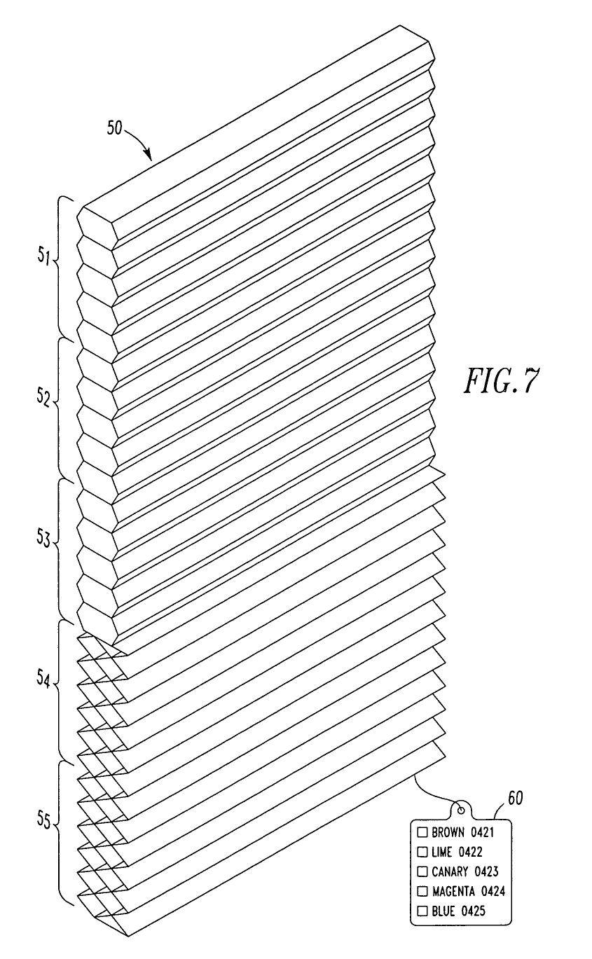

Another present preferred embodiment does not require the inclusion of any strips, but has indicia 26a located on at least one segment 41. The indicia may be imprinted on each segment 41 or some, but not all segments, as shown in FIG. 6. Alternatively, the indicia may be located on a label (not shown) that is on the at least one segment.

It should be understood that the indicia 26a could identify the segment 41 by any method of identification, including, but not limited to color, name, SKU number, fabric type, or fabric pattern. Moreover, the indicia could identify more than one segment of the plurality of different segments.

In another present preferred embodiment shown in FIG. 7, the indicia 36 may be located on a tag 60 attached to one segment 55 of the many segments 51, 52, 53, 54, and 55 that form the sampling device 50. The tag 60 may be attached by string, plastic, or other material such that the tag hangs from the segment 53. It should be understood that multiple tags could be used, wherein each tag could be attached to different segments or all tags could be attached to the same segment. Moreover, each tag could be attached in a different manner. In this embodiment two of the segments 54, 55 are double cell material while the other segments 51, 52, 53 are single cell.

In yet another embodiment we provide a kit having a plurality of different segments of at least one window covering material that forms a sample panel and a separated segment identifier having indicia that identifies at least one segment of the plurality of different segments. In this kit one could use a segment identifier similar to strip 6 shown in FIG. 2 which has indicia 11, 12, 13 to identify at least one segment of the plurality of different segments. The strip 6 could be folded along folding edges 15 or cut into segments 14 that are bound together.

Although we have illustrated our sampling panel as containing several different segments of a window covering material, one could also create a similar sampling display using several segments of the same fabric which is available for a window covering material in which segments differ only in color or texture. If this type of sampling device is constructed indicia identifying the respective segments should be applied on or adjacent each segment as shown in the embodiments of FIGS. 3 through 6. Otherwise, the customer may have difficulty in identifying the fabric that he or she has selected.

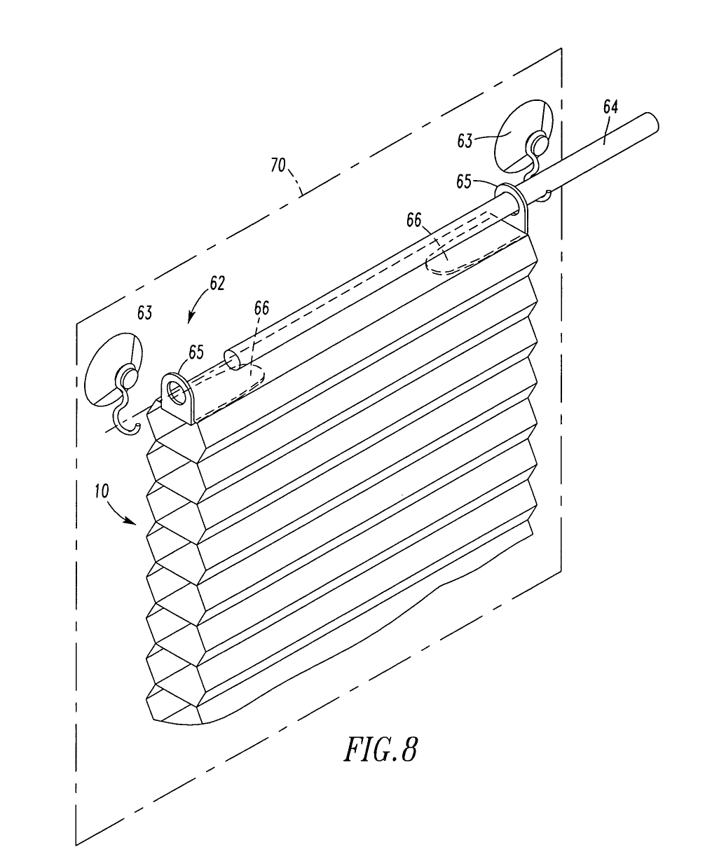

One advantage of our sampling system is that it can be easily mounted on a window using a simple mounting device, such as mounting 62 shown in FIG. 8. That mounting device 62 has a pair of suction cups 63 with hooks that hold a rod 64. Brackets 65 are slid onto the rod, each bracket having a tongue 66 that fits into the top cell or which can clip onto the top rail, if present in the sample. Those skilled in the art will recognize that the rod 64 could be passed through the upper cell in the panel thereby eliminating the need for the brackets 65. The suction cups can then be mounted on a window 70 or other slick surface. When the sample is mounted on a window a prospective customer can readily see how sunlight affects the various materials that make up the sample 10.

While we have shown and described certain present preferred embodiments of our sampling device and have illustrated certain present preferred methods of practicing the same, it is to be distinctly understood that the invention is not limited thereto, but may be otherwise variously embodied and practiced within the scope of the following claims.

We claim:

1. An apparatus for displaying window covering samples comprising:
a plurality of different segments of at least one window covering material attached in series to form a sample panel;
at least one strip being attached to at least one segment of the plurality of different segments; and
indicia located on at least one strip, the indicia identifying at least one of the plurality of different segments.

2. The apparatus of claim 1, wherein there is at least one strip attached to each segment of the plurality of different segments and indicia located on each strip, the indicia identifying at least one segment of the plurality of different segments.

3. The apparatus of claim 1, wherein the sample panel has a first pair and a second pair of substantially parallel sides and at least one strip extends beyond at least one side of said panel.

4. The apparatus of claim 1, wherein the sample panel has a front face and a rear face and at least one strip extends beyond at least one of the front face and the rear face.

5. The apparatus of claim 1, wherein at least one segment of the plurality of different segments of window covering material is selected from the group consisting of cellular fabric, pleated fabric, single cell cellular fabric, double cell cellular fabric, triple cell cellular fabric, cellular film, pleated film, single cell cellular film, double cell cellular film, triple cell cellular film, plastic slats, metal slats, and woven wood.

6. The apparatus of claim 1, wherein the at least one strip is cardboard, plastic, or paper.

7. The apparatus of claim 1, wherein the indicia identify at least one segment of said plurality of different segments by at least one of color, name, product number, order number, SKU number, fabric type, and fabric pattern.

8. The apparatus of claim 1, wherein at least one of the segments of the plurality of different segments is a woven fabric and at least one other segment of the plurality of different segments is a non-woven fabric.

9. The apparatus of claim 1, wherein the sample panel has a width of six inches to twenty-four inches and a fully extended length of twelve inches to thirty-six inches.

10. The apparatus of claim 1 also comprising a mounting device connected to at least one of the plurality of segments, the mounting device capable of mounting the sample panel over a window.

11. An apparatus for displaying window covering samples comprising:
a plurality of different segments of at least one window covering material attached in a series to form a sample panel; and
indicia located on at least one segment of the plurality of different segments and identifying at least one segment of the plurality of different segments.

12. The apparatus of claim 10 wherein at least one segment of said plurality of different segments of at least one window covering material is selected from the group consisting of cellular fabric, pleated fabric, single cell cellular fabric, double cell cellular fabric, triple cell cellular fabric, cellular film, pleated film, single cell cellular film, double cell cellular film, triple cell cellular film, plastic slats, metal slats, and woven wood.

13. The apparatus of claim 11 wherein the indicia are on each segment of the plurality of different segments.

14. The apparatus of claim 11 wherein the indicia are imprinted on at least one of the plurality of different segments.

15. The apparatus of claim 111 wherein the indicia identifies at least one segment of said plurality of different segments by at least one of color, name, fabric type, fabric pattern, product number, order number, or SKU number.

16. The apparatus of claim 11 wherein the indicia appear on at least one label attached to at least one segment of the plurality of segments.

17. The apparatus of claim 11 wherein at least one segment of the plurality of different segments is a woven fabric and at least one other segment of the plurality of different segments is a non-woven fabric.

18. The apparatus of claim 11, wherein the sample panel has a width of six inches to twenty-four inches and a fully extended length of twelve inches to thirty-six inches.

19. The apparatus of claim 11 also comprising a mounting device connected to at least one of the plurality of segments, the mounting device capable of mounting the sample panel over a window.

20. A kit for displaying window covering samples comprising:
a plurality of different segments of at least one window covering material attached in a series to form a sample panel; and
a segment identifier, the segment identifier having at least one identifying member, each identifying member having indicia that identifies at least one segment of the plurality of different segments.

21. The kit of claim 20, wherein at least one segment of said plurality of different segments is a woven fabric and at least one other segment of said plurality of different segments is a non-woven fabric.

22. The kit of claim 20, wherein at least one segment of said plurality of different segments is selected from the group consisting of cellular fabric, pleated fabric, single cell cellular fabric, double cell cellular fabric, triple cell cellular fabric, cellular film, pleated film, single cell cellular film, double cell cellular film, and triple cell cellular film, plastic slats, metal slats, and woven wood.

23. The kit of claim 20, wherein the indicia identifies at least one segment of said plurality of different segments by at least one of color name, fabric type, fabric pattern, product number, order number, or SKU number.

24. The kit of claim 20 also comprising a mounting device capable of being connected to at least one of the segments and of mounting the sample panel over a window.

25. An apparatus for displaying window covering samples comprising:
a plurality of different segments of at least one window covering material attached in a series to form a sample panel;
at least one tag attached to at least one segment of said plurality of different segments; and
indicia located on at least one of the at least one tag identifying at least one segment of the plurality of different segments.

26. The apparatus of claim 25 wherein at least one segment of said plurality of different segments of at least one window covering material is selected from the group consisting of cellular fabric, pleated fabric, single cell cellular fabric, double cell cellular fabric, triple cell cellular fabric, cellular film, pleated film, single cell cellular film, double cell cellular film, triple cell cellular film, plastic slats, metal slats, and woven wood.

27. The apparatus of claim 25, wherein the indicia are on each tag.

28. The apparatus of claim 25, wherein the indicia identifies at least one segment of said plurality of different segments by at least one of color, name, fabric type, fabric pattern, product number, order number, or SKU number.

29. The apparatus of claim 25, wherein the indicia appear on at least one hang tag, the at least one hang tag being attached to at least one segment of the plurality of different segments.

30. The apparatus of claim 25 wherein at least one segment of the plurality of different segments is a woven fabric and at least one other segment of the plurality of segments is a non-woven fabric.

31. The apparatus of claim 25, wherein the sample panel has a width of six inches to twenty-four inches and a fully extended length of twelve inches to thirty-six inches.

32. The apparatus of claim 25 also comprising a mounting device connected to at least one of the plurality of segments, the mounting device capable of mounting the sample panel over a window.

33. An apparatus for displaying window covering samples comprising:
a plurality of segments of fabric available for use as a window covering material attached in series to form a sample panel, the segments differing from one another in at least one of color and texture; and
indicia located on or adjacent each segment, the indicia on or adjacent each segment and identifying that segment.

34. The apparatus of claim 33, wherein there is one strip attached to each segment of the fabric and the indicia are located on each strip, the indicia one each strip identifying the segment to which that strip is attached.

35. The apparatus of claim 33 also comprising a mounting device connected to at least one of the plurality of segments, the mounting device capable of mounting the sample panel over a window.
